(19) United States
(12) Patent Application Publication
(10) Pub. No.: US 2014/0270287 A1
(43) Pub. Date: Sep. 18, 2014

(54) BLUETOOTH HEARING AIDS ENABLED DURING VOICE ACTIVITY ON A MOBILE PHONE

(71) Applicant: QUALCOMM INCORPORATED, San Diego, CA (US)

(72) Inventor: Kee-Hyun PARK, San Diego, CA (US)

(73) Assignee: QUALCOMM INCORPORATED, San Diego, CA (US)

(21) Appl. No.: 13/831,754

(22) Filed: Mar. 15, 2013

(51) Int. Cl. H04R 25/00

(52) U.S. Cl. CPC H04R 25/558
USPC 381/313; 381/315

(57) ABSTRACT

A hearing aid device and methods implemented in hearing aid devices activate a radio frequency (RF) transceiver for communicating sounds signals for remote processing on a mobile computing device in response to the device detecting reception of meaningful sound, such as speech. Selectively activating the RF transceiver when sound is meaningful and avoiding powering the RF transceiver when detected sound is of little value to the wearer enables hearing aid to use the mobile computing device to process meaningful sound signals (e.g., speech from another person) while conserving batter power, thereby prolonging its battery life. The hearing aid device and methods may also deactivate the RF transceiver when the hearing aid device does not detect a meaningful sound signal.

### BACKGROUND

Hearing aid devices assist hearing-impaired people by outputting amplified audio signals that have been received by a microphone and processed by a processor as audible sound. Sound processing may occur in the hearing aid device itself and may require a significant amount of power from the hearing aid device's battery. Because processors with the processing capacity to output higher-quality sound consume more power than lower-quality processors, sound processors in hearing aid devices generally have lower processing capabilities in order to extend the hearing aid device's battery life. These lower quality processors may only perform limited sound processing, and as a result, users of hearing aid devices may experience lower quality sounds and a diminished range of hearing. These limitations may negatively affect a user's experience, especially for some types of sounds, such as live music.

### SUMMARY

The various embodiments provide for a hearing aid system that uses a mobile computing device with a high capacity processor, such as a smart phone, to process audio signals remotely when sound patterns indicate that the user is listening to meaningful sound, such as speech, but not when sound patterns indicate only non-meaningful sounds are present. In the various embodiments, a hearing aid system may include one or two battery-powered hearing aid devices (depending on the individual) that may communicate with the mobile computing device such as via a Bluetooth link, at least one microphone, and at least one speaker. The various embodiments provide that a hearing aid device may activate a radio-frequency (RF) transceiver for transmitting audio signals for remote processing in response to recognizing a meaningful sound in audio signals received from a microphone and deactivating the transceiver at other times, thereby prolonging the hearing aid device's battery and increasing overall user experience.

In an embodiment, a hearing aid device may receive an audio signal from a microphone directed to the front side of the hearing aid device's user. The hearing aid device may determine whether the audio signal indicates a meaningful sound (e.g., a person speaking to the hearing aid device's user). In response to determining that the audio signal indicates a meaningful sound, the hearing aid device may activate a RF transceiver and transmit the audio signal to the mobile computing device over a wireless data link connection (e.g., a Bluetooth® Low Energy connection or a Bluetooth® synchronous connection-oriented link). The audio signal of a meaningful sound may be processed by the mobile computing device's higher capacity processor. A processed audio signal may be transmitted back to the earpiece where it may be played through the speaker. This process may continue so long as the hearing aid device recognizes a meaningful sound in the audio signal, and the processor may deactivate the RF transceiver when a meaningful sound is no longer recognized.

In another embodiment, a hearing aid device may receive directed sounds on a first microphone that is directed to the front of the user (i.e., a unidirectional microphone) and background sounds on a second microphone that may be configured to receive sounds from all directions (i.e., an omnidirectional microphone). In response to the hearing aid device's detecting an audio signal indicating a meaningful sound on the first microphone (e.g., a person speaking at the user), the hearing aid device may activate an RF transceiver. Additionally, upon detecting an audio signal indicating a meaningful sound, the hearing aid device may implement signal subtraction to isolate the audio signal of a meaningful sound received on the first microphone from the background sound signals received on the second microphone. The hearing aid device may transmit the isolated audio signal of a meaningful sound to a mobile computing device where it may be processed and sent back to the hearing aid device to be played through the hearing aid device's speaker. This process may continue so long as the hearing aid device recognizes a meaningful sound in the audio signal, and the hearing aid device may deactivate the RF transceiver when not detecting an audio signal of a meaning sound.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIG. 2 is a component block diagram of a hearing aid system employing a microphone according to an embodiment.

FIG. 3 is an embodiment call flow relationship between a sound source environment, a hearing aid device utilizing a microphone, and a mobile computing device.

FIG. 4 is a process flow diagram illustrating an embodiment method for transmitting only meaningful sound signals from a hearing aid device coupled to a microphone to a mobile computing device for remote processing.

FIG. 5 is a component block diagram of a hearing aid system employing two microphones according to an embodiment.

FIG. 6 illustrates an embodiment call flow relationship between a sound source, a hearing aid device employing two microphones, and a mobile computing device.

FIG. 7 is a process flow diagram illustrating an embodiment method for transmitting only meaningful sound signals from a hearing aid device that utilizes two microphones to a mobile computing device for remote processing.

FIG. 8 is a component diagram of an example mobile computing device suitable for use with the various embodiments.

FIG. 9 is a component diagram of an embodiment of an example hearing aid device.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “mobile computing device” refers to any one or all of cellular telephones, tablet computers, personal data assistants (PDAs), palm-top computers, notebook computers, laptop computers, personal computers, wireless electronic mail receivers and cellular telephone receivers (e.g., the Blackberry® and Treo® devices), multimedia Internet enabled cellular telephones (e.g., Blackberry Storm®), multimedia enabled smart phones (e.g., Android® and Apple iPhone®), and similar electronic devices that include a programmable processor, memory, a communication transceiver, and a display.

Modern hearing aid devices must generally make a trade-off between battery life on one hand and processing power on the other. Given the relative complexity of processing audio signals, hearing aid devices generally offer lower quality sound processing (and, therefore, lower quality sound) in exchange for a longer battery life. One technique to obtain better audio quality is to transmit audio signals received by a hearing aid device's microphone to a mobile computing device (e.g., a smartphone) to use the superior processing powers of that mobile computing device to produce a higher quality audio signal. A hearing aid device with a power-efficient processor may thus provide higher quality audio by processing the audio signal in the mobile computing device.

While remotely processing audio signals on a mobile computing device shifts a large power-consuming task away from the hearing aid device, the hearing aid device must expend energy powering the transceiver to transmit unprocessed audio signals to the mobile computing device and receive processed audio signals from the mobile computing device. Continuously transmitting data to and receiving data from a mobile computing device will run down the battery, which is undesirable, particularly when the ambient sound detected by the microphone is of little or no value to the wearer (e.g., noise).

Some groups of hearing-impaired people, such as seniors, are exposed to sounds throughout the day that may require their attention for only approximately 3-5 hours in total. At other times, these individuals may only be exposed to ambient noise or other background sounds. Because extending the life of a battery in hearing aid devices remains important, there is a need to use battery power more effectively throughout the day to extend the operating time of a hearing aid device while still processing and playing high-quality sound for the hearing aid device's user.

In overview, the various embodiments provide a hearing aid device and methods implemented in hearing aid devices that activate an RF transceiver for communicating sounds signals for remote processing on a mobile computing device in response to the hearing aid device detecting reception of meaningful sound (e.g., speech). By selectively activating the RF transceiver when sound is meaningful and avoiding powering the RF transceiver when the detected sound is of little value to the wearer, the hearing aid device may be enabled to use the mobile computing device to process meaningful sound signals (e.g., speech signals) while conserving battery power, thereby prolonging the hearing aid device's battery life. The various embodiments may also provide methods for deactivating a hearing aid device's RF transceiver when the hearing aid device does not detect a meaningful sound signal. The various embodiments promote a user's experience by improving sound quality with the complex audio processing made possible by utilizing the processing resources from the mobile computing device without unnecessarily draining the hearing aid device's battery. The various embodiments further promote a user's experience by more effectively using battery power and extending the hearing aid device's overall operational time by selectively transmitting only meaningful sound signals for remote processing on the mobile computing device.

In the various embodiments, a hearing aid device may include a processor, various antennas, at least one microphone, a speaker, an RF transceiver, and a power source. The RF transceiver may be a short-range, low-power radio transceiver, such as a Bluetooth® transceiver, configured to establish a wireless data link with a suitably equipped mobile computing device and/or another hearing aid device. In an embodiment, a hearing aid device may operate in conjunction with another hearing aid device, while in another embodiment a hearing aid device may operate independently. In another embodiment, at least one hearing aid device may operate in conjunction with a mobile computing device.

In the various embodiments, on detecting a meaningful sound signal, a hearing aid device may energize its radio transceiver for transmission of a meaningful sound signal to a mobile computing device, where the meaningful sound signal may be processed and returned to the hearing aid device. In an embodiment, a hearing aid device may detect a meaningful sound signal by analyzing sound signals sent by a microphone with a speech detection module.

In another embodiment, the hearing aid device may receive a meaningful sound signal on a unidirectional microphone and may receive background sound signals from an omnidirectional microphone. The hearing aid device may remove the background sound signals from the meaningful sounds signals through signal subtraction before transmitting the isolated meaningful sound signals (i.e., isolated audio signals) to a mobile computing device for remote processing.

FIG. 1 illustrates a wireless network system 100 suitable for use with the various embodiments. The wireless network system 100 may include multiple devices, such as a first hearing aid device 102, an optional second hearing aid device 104, and a first mobile computing device 120 (e.g., a smart phone). The first hearing aid device 102 may receive sounds on at least one microphone from a sound source 130 through a sound medium 152. The sound source 130 may be, for example, a person speaking in the direction of the first hearing aid device 102. In another example, the sound source 130 may be background sounds such as automobile noise near a busy highway. The first and second hearing aid devices 102 and 104 may transform the sound received from the sound source 130 through the sound mediums 152 and 154, respectively, into sound signals. The first hearing aid device 102 may connect to the first mobile computing device 120 through a wireless data link 172 to transmit and receive sound signals. As an example, the wireless data link 172 may be a Bluetooth® connection. In a further example, the Bluetooth® connection may be a synchronous connection-oriented link. Similarly, the optional second hearing aid device 104 may exchange data with a first mobile computing device 120 over a wireless data link 174. As an example, the wireless data link 174 may be a Bluetooth® connection.

FIG. 2 illustrates a hearing aid system 200 employing one microphone. A hearing aid device 102 may include a casing 201, in which is positioned a controller module 212, which may be a traditional central processing unit (CPU), a digital signal processor (DSP), or any other means of carrying out instructions on the hearing aid device 102. The hearing aid device 102 may also include a microphone 216 for receiving sounds, which may be positioned on or in the hearing aid device casing 201. The microphone 216 may generate sound signals representative of incident sound. A speech detection module 218 may be implemented as a software module executing within the controller module 212 or as a separate circuit that may be coupled to the microphone 216 and configured to analyze sound signals received from the microphone 216 to determine whether the sound signals represent meaningful sound, such as speech. Since in most applications users will find speech to be meaningful to them compared to the background noise of everyday life, references made herein to meaningful sound will normally encompass speech, including recorded speech and computer-generated speech. However, meaningful sound may encompass other sounds that a user may designate as important or sufficiently meaningful enough to use the battery power necessary to process the sound signals using the higher capacity of their mobile computing device, such as music, movie sounds, etc.

The hearing aid device 102 may also include a power management unit 210 that may, among other things, energize and de-energize a radio frequency transceiver 204 (i.e., a RF transceiver 204) and may be implemented in software or hardware. The RF transceiver 204 may be in communication with a Bluetooth® baseband unit 206 and at least one antenna 202. The Bluetooth® baseband unit 206 may implement media access and physical layer procedures to support the exchange of data over a Bluetooth® connection (e.g., over a Bluetooth® synchronous connection-oriented (SCO) link) and may be implemented in software or hardware. The hearing aid device 102 may also include an audio codec unit 208, which may also be implemented in software or hardware. The audio codec unit may, in part, prepare audio signals for output through a speaker 214. The speaker 214 may transform processed sound signals into audible sounds that may be heard by a user of the hearing aid device 102.

FIG. 3 illustrates an embodiment of signaling and call flows 300 among a sound source 130, a hearing aid device 102 employing a microphone 216, and a mobile computing device 120. The sound source 130 may be a person and the sound may be someone speaking (i.e., a sound of speech 304), which is captured on a microphone 216 in operation 306. The microphone 216 may be directed toward the front of the hearing aid device 102's user and may convert the sound of speech received from the sound source 130 into sound signals that are sent to a speech detection module 218 within the hearing aid device 102. The speech detection module 218 may analyze the sound signals in operation 308. If the speech detection module 218 detects a speech sound signal (i.e., detects a meaningful sound signal), the hearing aid device 102 may activate a RF transceiver 204 in operation 310. After activating the RF transceiver 204, the hearing aid device 102 may transmit the speech sound signal 312 to a mobile computing device 120 for processing. In an embodiment, the hearing aid device 102 may establish a Bluetooth® Low Energy data connection with the mobile computing device 120 to transfer the speech sound signal. After the speech sound signal arrives at the mobile computing device 120, the mobile computing device may use its signal processing functions (e.g., a digital signal processor) in operation 314 to put the speech sound signal in a preferable form for playing. Once processing terminates, the mobile computing device 120 may wirelessly transmit the processed speech sound signal 316 to the hearing aid device 102. In an embodiment, the mobile computing device 120 may establish a Bluetooth® Low Energy data connection over which the hearing aid device 102 may transfer the processed speech sound signal. In a further example, the mobile computing device 120 may establish a Bluetooth® synchronous connection-oriented link with the hearing aid device 102. After receiving the processed speech sound signal, the hearing aid device 102 may play the processed speech sound signal through a speaker 214 in operation 318. If the speech detection module 218 no longer detects a speech sound signal (i.e., a meaningful sound signal) being sent by the microphone 216, the hearing aid device 102 may deactivate the RF transceiver in operation 320, which may conserve battery power.

FIG. 4 illustrates an embodiment hearing aid device method 400 for remotely processing speech sound signals transmitted by a hearing aid device with one microphone. A hearing aid device 102 may, in block 402, enable a microphone 216 to receive sounds. In block 306, the microphone 216 may receive sounds. In an embodiment, the microphone may turn those sounds into sound signals. The hearing aid device 102 may analyze the sound signals in block 308. In an embodiment, the hearing aid device 102 may analyze the sound signals with a speech detection module 218 to determine whether the sound signal contains speech (i.e., a speech sound signal). If the speech detection module 218 does not detect a speech sound signal (i.e., determination block 404=“No”), the hearing aid device 102 may deactivate the RF transceiver 204 in block 320. In various embodiments, deactivating the RF transceiver 204 when no meaningful sound (e.g., speech) is detected may conserve the hearing aid device 102's battery power. In an embodiment, the hearing aid device 102 may only deactivate the RF transceiver 204 if the RF transceiver is already activated. For example, the RF transceiver may have been active because speech was previously detected, and speech is now no longer detected. The hearing aid device 102 may continue operating in block 306.

If a speech sound signal is detected (i.e., determination block 404=“Yes”), the hearing aid device 102 may activate its RF transceiver in block 310 if the transceiver is deactivated. For example, the hearing aid device may activate the RF transceiver when speech is detected for the first time since the RF transceiver was last deactivated (i.e., since the last time it stopped detecting speech or another meaningful sound). The hearing aid device 102 may wirelessly transmit the speech sound signal to a mobile computing device 120 for processing in block 406. In an embodiment, the hearing aid device 102 may wirelessly transmit the speech sound signal to the mobile computing device 120 over a Bluetooth® link. For example, the Bluetooth® link may be a synchronous connection-oriented link. The hearing aid device 102 may continue operating in block 306, receiving sounds signals from the microphone 216 and repeating the above method.

After being transmitted to the mobile computing device 120, the speech sound signal may be processed using the mobile computing device 120's signal processing capabilities in block 314. In an embodiment, the mobile computing device 120 may process the signal using a digital signal processor. The hearing aid device 102 may receive the processed speech sound signal from the mobile computing device 120 in block 408. The hearing aid device 102 may play the processed speech sound signal through a speaker 214 to a user in block 318. By selecting only meaningful sounds (e.g., speech sounds) for transmission to the mobile computing device 120 for processing, the hearing aid device may achieve lower power consumption.

In an embodiment, the hearing aid device 102 may be simultaneously or near-simultaneously receiving sounds on a microphone 216, receiving processed sound signals from the mobile computing device 120, and playing the processed sound signal through a speaker 214 to a user.

FIG. 5 illustrates an embodiment block component diagram 500 for a hearing aid device that receives sound input from an omnidirectional microphone 522 and a unidirectional microphone 520. A hearing aid device 102 may include various component parts that may be included inside or be fastened to the exterior of a hearing aid device casing 501. In an embodiment, a hearing aid device 102 may include a unidirectional microphone 520 that may capture sounds received from a particular direction and transform them into sound signals. In a further embodiment, the unidirectional microphone 520 may be positioned to detect speech directed towards the user's face (i.e., detect when someone is speaking to the user). The unidirectional microphone 520 may be in communication with a speech detection module 518, which may detect speech in sounds signals received from the unidirectional microphone 520.

A hearing aid device may also include a second microphone, which may be an omnidirectional microphone 522. The omnidirectional microphone 522 may be sensitive to sounds from any direction and may function to receive background sounds. In an embodiment, a dual microphone input processor 516 may subtract signals sent by the omnidirectional microphone 522 from signals sent by the unidirectional microphone 520 to produce isolated sound signals. For example, the dual microphone input processor 516 may receive sound signals from the unidirectional microphone 520, which may be comprised of a strong speech sound signal and a weak background noise signal, and the signals from the omnidirectional microphone 522, which may be comprised of a weak speech sound signal and a strong background noise signal; may subtract the strong background signal from the signals received from the unidirectional microphone 520; and may output an isolated speech sound signal.

In an embodiment, the dual microphone input processor 516 may be in communication with a controller 512 included within the hearing aid device casing 501. The controller 512 may be a traditional central processing unit (CPU), a digital signal processor (DSP), or any other means of carrying out instructions on the hearing aid device 102. The hearing aid device 102 may also include a power management unit 510, which may, among other things, be configured to activate and deactivate a radio frequency transceiver 504 in response to detecting or not detecting, respectively, a speech sound signal from the unidirectional microphone 520. A RF transceiver 504 may be in communication with a Bluetooth® baseband unit 506 and at least one antenna 502. The Bluetooth® baseband unit 506 may implement medium access and physic layer procedures to support the exchange of data. The hearing aid device may also include an audio codec unit 508. The audio codec unit may, in part, prepare audio signals for output through a speaker 514. The speaker 514 may transform processed sound signals into audible sound that may be heard by a user of the hearing aid device 102.

FIG. 6 illustrates signaling and call flows 600 among a sound source, a hearing aid device that implements two microphones, and a mobile computing device in an embodiment. Sound, including background noise 602, may be generated at a sound source 130 and may travel to the hearing aid device 102. Upon reaching the hearing aid device 102 from any direction, background noise may be captured with an omnidirectional microphone 522, which may convert the background noise into a background sound signal. Another sound source 130 may be a person speaking in the direction of the hearing aid device 102 and the unidirectional microphone 520 (i.e., a person speaking to the hearing aid device 102's user). The sound of speech 304 may travel to the hearing aid device 102. The hearing aid device 102 may captured the sound of speech 304 in operation 606 with a unidirectional microphone 520 included on or in the hearing aid device 102. The unidirectional microphone 520 may convert the sound of speech into a speech sound signal. The signal from the unidirectional microphone 520 may be processed by the hearing aid device 102's speech detection module 518 in operation 608 to determine whether the unidirectional microphone 520 is receiving the sound of speech (i.e., whether someone is speaking to the hearing aid device 102's user). In response to the speech detection module 518's recognition of a speech sound signal, the hearing aid device 102 may activate its RF transceiver 504 in operation 610. The hearing aid device 102's dual microphone input processor 516 may, in operation 612, subtract the background sound signals received from the omnidirectional microphone 522 from the speech signal received from the unidirectional microphone 520. This subtraction may isolate the speech sound signal from background noise. After being activated, the RF transceiver 504 may receive the isolated speech sound signal and wirelessly transmit the isolated speech sound signal 614 through the hearing aid device 102's antenna 502 to a mobile computing device 120 for processing. For example, the hearing aid device may transmit the isolated speech sound signal to the mobile computing device through a Bluetooth® Low Energy data link. In a further example, the hearing aid device may transmit the isolated speech sound signal to the mobile computing device through a Bluetooth® synchronous connection-oriented link.

In an embodiment, a mobile computing device 120 may receive the isolated speech sound signal 614 from the hearing aid device 102 through a wireless data link (e.g., a Bluetooth® Low Energy data link). The mobile computing device 120 may process the isolated speech sound signal. For example, the mobile computing device 120 may process the isolated speech sound signal using a digital signal processor. In an embodiment, the mobile computing device 120 may apply enhancements, such as equalization or filtering, to the isolated speech sound signal. After processing the isolated speech sound signal, the mobile computing device 120 may wirelessly transmit the processed, isolated speech sound signal 618 to the hearing aid device 102. For example, the mobile computing device 120 may establish a Bluetooth® Low Energy connection to the hearing aid device in order to transmit the processed, isolated speech sound signal.

In an embodiment, after receiving the processed, isolated speech sound signal, a hearing aid device 102 may send the processed, isolated speech sound signal to a speaker 514 included within or fastened to the exterior of the hearing aid device casing 501. The hearing aid device 102's speaker 514 may play the processed, isolated speech sound signal in operation 620, turning the processed, isolated speech sound signal into audible sound that the hearing aid device 102's user may experience. In operation 622, the hearing aid device 102 may deactivate the RF transceiver 504 if the speech detection module 518 no longer detects speech in signals from the unidirectional microphone 520.

FIG. 7 illustrates an embodiment hearing aid device method 700 for remotely processing sounds of speech on a mobile computing device sent by a hearing aid device with two microphones.

In an embodiment, a hearing aid device 102 may enable a unidirectional microphone 520 in block 702. The hearing aid device 102 may also enable an omnidirectional microphone 522 in block 704. While enabled, these microphones may receive sounds and convert these sounds into sound signals. The omnidirectional microphone 522 may receive background sound signals from sound sources 130 in block 604. For example, the omnidirectional microphone may receive sounds from passing automobiles, lawnmowers, or other ambient noises. In an embodiment, in block 606, the unidirectional microphone 520 may receive sounds from sound sources 130 that are directed at the unidirectional microphone 520. In a further embodiment, the unidirectional microphone 520 may be positioned on or with respect to the hearing aid device 102 such that it may detect the sounds of someone speaking directly to the hearing aid device 102's user. In block 608 a speech detection module 518 in communication with the unidirectional microphone 520 may analyze the sound signals received from the unidirectional microphone 520 to determine whether the unidirectional microphone 520 has received the sound of speech (i.e., whether the unidirectional microphone 520 has detected someone speaking directly to the user of the hearing aid device 102).

If the speech detection module 518 does not detect speech sounds in the signals received from the unidirectional microphone 520 in determination block 706 (i.e., determination block 706=“No”), the hearing aid device 102 may deactivate its RF transceiver in block 622 if the transceiver is already activated. For example, the hearing aid device 102 may deactivate the RF transceiver when the speech detection module no longer detects speech sounds. In this example, the hearing aid device transceiver may have already been activated in response to the speech detection module 518's previously detecting the sound of speech. The hearing aid device 102 may continue operating in block 604. In an embodiment, the hearing aid device 102 may continue to receive sounds on its omnidirectional microphone 522 and sounds on its unidirectional microphone 520 and may continuously analyze the signals from the unidirectional microphone 520 for speech sounds.

If the speech detection module 518 detects speech (i.e., determination block 706=“Yes”), the hearing aid device 102 may activate the RF transceiver 504 in block 610. In an embodiment, the hearing aid device may activate the RF transceiver 504 when the speech detection module 518 detects speech sounds in the signal received from the unidirectional microphone 520.

The hearing aid device 102 may also utilize the dual microphone input processor 516 to isolate speech sound signals from the other sound signals received from the unidirectional microphone 520. In block 612, the dual microphone input processor 516 may subtract the background sound signals received from the omnidirectional microphone 522 from the speech sound signal and background sound signal received from the unidirectional microphone 520. By subtracting the sounds received by the omnidirectional microphone 522 (e.g., background noise) from the sounds received by the unidirectional microphone 520 (e.g., background noise and speech), the dual microphone input processor 516 may isolate meaningful sounds for remote processing (e.g., speech signals). In an embodiment, the dual microphone input processor 516 may remain inactive until the speech detection module 518 has detected a speech sound signal.

In block 708, the hearing aid device 102 may use the activated RF transceiver 504 to transmit the isolated speech sound signal to a mobile computing device through a wireless data link. For example, this data link may be a Bluetooth® Low Energy connection. The hearing aid device 102 may continue operating in block 604. In an embodiment, the hearing aid device 102 may continue to receive sounds on its omnidirectional microphone 522 and sounds on its unidirectional microphone 520 and may continuously analyze the signals from the unidirectional microphone 520 for speech sounds.

The mobile computing device 120 may process the isolated speech sound signal in block 616. In an embodiment, the mobile computing device 120 may have received the isolated speech sound signal from the hearing aid device 102's transmission in block 708. In another embodiment, the mobile computing device 120 may use its audio signal processing capabilities. By utilizing its powerful signal processing capabilities, the mobile computing device 120 may produce a high-quality sound signal that may be later played for the hearing aid device 102's user. The processed speech sound signals may be wirelessly received on the hearing aid device 102 from the mobile computing device 120 in block 710.

The hearing aid device 102 may play the processed speech sound signals in the speaker 514 in block 620. For example, the speaker 514 may play the sound of another person speaking to the hearing aid device 102's user, which may allow the user to understand and respond to that other person.

The various embodiments may be implemented in any of a variety of mobile computing devices, an example of which is illustrated in FIG. 8. For example, the mobile computing device 800 may include a processor 802 coupled to internal memory 804. Internal memory 804 may be volatile or non-volatile memory, and may also be secure and/or encrypted memory, or unsecure and/or unencrypted memory, or any combination thereof. The processor 802 may also be coupled to a touch screen display 806, such as a resistive-sensing touch screen, capacitive-sensing touch screen infrared sensing touch screen, or the like. Additionally, the display of the mobile computing device 800 need not have touch screen capability. Additionally, the mobile computing device 800 may have one or more antenna 808 for sending and receiving electromagnetic radiation that may be connected to a wireless data link and/or cellular telephone transceiver 816 coupled to the processor 802. The mobile computing device 800 may also include physical buttons 812a and 812b for receiving user inputs. The mobile computing device 800 may also include a power button 818 for turning the mobile computing device 800 on and off.

The various embodiments described above may also be implemented within a variety of hearing aid devices, such as hearing aid device 900, which is illustrated in FIG. 9. A hearing aid device 900 may include a processor 902 coupled to internal memory 904. Internal memory 904 may be volatile or non-volatile memory, and may also be secure and/or encrypted memory, or unsecure and/or unencrypted memory, or any combination thereof. The hearing aid device 900 may include a physical button 914 for receiving user inputs. Additionally, the hearing aid device 900 may have one or more antenna 912 for sending and receiving electromagnetic radiation that may be connected to a wireless data link transceiver 908 and coupled to the processor 902. The hearing aid device 900 may include a speaker 920 coupled to the processor 902 and configured to generate sound. The hearing aid device 900 may also include a unidirectional microphone 916 coupled to the processor 902 and configured to receive an audio input. The hearing aid device 900 may also include an omnidirectional microphone 918 coupled to the processor 902 and configured to receive an audio input.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for remotely processing meaningful sound signals received on a hearing aid device to conserve battery power, comprising:
receiving sound signals from a microphone;
determining whether the sound signals represent meaningful sound;
activating a transceiver in response to determining that the sound signals represent meaningful sound;
transmitting the sound signals to a mobile computing device via the transceiver;
receiving processed sound signals from the mobile computing device;
generating sound from the received processed sound signals; and
deactivating the transceiver when the transceiver is active in response to determining that the sound signals do not represent meaningful sound.

2. The method of claim 1, wherein determining whether the sound signals represent meaningful sound comprises processing the sound signals using a speech detection module to detect speech.

3. The method of claim 1, wherein transmitting the sound signals comprises transmitting the sound signals over one of a Bluetooth® synchronous connection-oriented link and a Bluetooth® Low Energy connection.

4. The method of claim 1, further comprising:
receiving the transmitted sound signals on the mobile computing device;
processing on the mobile computing device the sound signals; and
transmitting the processed sound signals from the mobile computing device to the hearing aid device.

5. The method of claim 4, wherein processing the sound signals on the mobile computing device comprises processing the sound signals on a digital signal processor.

6. The method of claim 1, wherein receiving sound signals from a microphone comprises:
receiving sound signals from a unidirectional microphone configured to preferentially receive sounds directed toward a user's face; and
receiving sound signals from an omnidirectional microphone configured to receive sounds from multiple directions.

7. The method of claim 6, wherein transmitting the sound signals to the mobile computing device via the transceiver comprises:
subtracting the sound signals received from the omnidirectional microphone from the sound signals received from the unidirectional microphone to produce isolated sound signals; and
transmitting the isolated sound signals to the mobile computing device via the transceiver.

8. A hearing aid device, comprising:
means for receiving sound signals from a microphone;
means for determining whether the sound signals represent meaningful sound;
means for activating a transceiver in response to determining that the sound signals represent meaningful sound;
means for transmitting the sound signals to a mobile computing device via the transceiver;
means for receiving processed sound signals from the mobile computing device;
means for generating sound from the received processed sound signals; and
means for deactivating the transceiver when the transceiver is active in response to determining that the sound signals do not represent meaningful sound.

9. The hearing aid device of claim 8, wherein means for determining whether the sound signals represent meaningful sound comprises means for processing the sound signals using a speech detection module to detect speech.

10. The hearing aid device of claim 8, wherein means for transmitting the sound signals comprises means for transmitting the sound signals over one of a Bluetooth® synchronous connection-oriented link and a Bluetooth® Low Energy connection.

11. The hearing aid device of claim 8, wherein means for receiving sound signals from a microphone comprises:
means for receiving sound signals from a unidirectional microphone configured to preferentially receive sounds directed toward a user's face; and
means for receiving sound signals from an omnidirectional microphone configured to receive sounds from multiple directions.

12. The hearing aid device of claim 11, wherein means for transmitting the sound signals to the mobile computing device via the transceiver comprises:
means for subtracting the sound signals received from the omnidirectional microphone from the sound signals received from the unidirectional microphone to produce isolated sound signals; and
means for transmitting the isolated sound signals to the mobile computing device via the transceiver.

13. A non-transitory processor-readable storage medium having stored thereon processor-executable instructions configured to cause a hearing aid device processor to perform operations comprising:
receiving sound signals from a microphone;
determining whether the sound signals represent meaningful sound;
activating a transceiver in response to determining that the sound signals represent meaningful sound;
transmitting the sound signals to a mobile computing device via the transceiver;
receiving processed sound signals from the mobile computing device;
generating sound from the received processed sound signals; and
deactivating the transceiver when the transceiver is active in response to determining that the sound signals do not represent meaningful sound.

14. The non-transitory processor-readable storage medium of claim 13, wherein the stored processor-executable instructions are configured to cause a hearing aid device processor to perform operations such that determining whether the sound signals represent meaningful sound comprises processing the sound signals using a speech detection module to detect speech.

15. The non-transitory processor-readable storage medium of claim 13, wherein the stored processor-executable instructions are configured to cause a hearing aid device processor to perform operations such that transmitting the sound signals comprises transmitting the sound signals over one of a Bluetooth® synchronous connection-oriented link and a Bluetooth® Low Energy connection.

16. The non-transitory processor-readable storage medium of claim 13, wherein the stored processor-executable instructions are configured to cause a hearing aid device processor to perform operations such that receiving sound signals from a microphone comprises:
receiving sound signals from a unidirectional microphone configured to preferentially receive sounds directed toward a user's face; and
receiving sound signals from an omnidirectional microphone configured to receive sounds from multiple directions.

17. The non-transitory processor-readable storage medium of claim 16, wherein the stored processor-executable instructions are configured to cause a hearing aid device processor to perform operations such that transmitting the sound signals to the mobile computing device via the transceiver comprises:
subtracting the sound signals received from the omnidirectional microphone from the sound signals received from the unidirectional microphone to produce isolated sound signals; and
transmitting the isolated sound signals to the mobile computing device via the transceiver.

18. A hearing aid device, comprising:
a memory;
a microphone;
a transceiver; and
a processor coupled to the memory, the microphone and the transceiver, wherein the processor is configured with processor-executable instructions to perform operations comprising:
receiving sound signals from the microphone;
determining whether the sound signals represent meaningful sound;
activating the transceiver in response to determining that the sound signals represent meaningful sound;
transmitting the sound signals to a mobile computing device via the transceiver;
receiving processed sound signals from the mobile computing device via the transceiver;
generating sound from the received processed sound signals; and
deactivating the transceiver when the transceiver is active in response to determining that the sound signals do not represent meaningful sound.

19. The hearing aid device of claim 18, wherein the processor is configured with processor-executable instructions to perform operations such that determining whether the sound signals represent meaningful sound comprises processing the sound signals using a speech detection module to detect speech.

20. The hearing aid device of claim 18, wherein the transceiver is one of a Bluetooth® transceiver and a Bluetooth® Low Energy transceiver.

21. The hearing aid device of claim 18, wherein:
the microphone is a unidirectional microphone configured to preferentially receive sounds directed toward a user's face;
the hearing aid device further comprises an omnidirectional microphone coupled to the processor and configured to receive sounds from multiple directions; and
the processor is configured with processor-executable instructions to perform operations such that receiving sound signals from the microphone comprises:
receiving sound signals from the unidirectional microphone; and
receiving sound signals from the omnidirectional microphone.

22. The hearing aid device of claim 21, wherein the processor is configured with processor-executable instructions to perform operations such that transmitting the sound signals to the mobile computing device via the transceiver comprises:
subtracting the sound signals received from the omnidirectional microphone from the sound signals received from the unidirectional microphone to produce isolated sound signals; and
transmitting the isolated sound signals to the mobile computing device via the transceiver.

23. A system, comprising:
a mobile computing device; and
a hearing aid device configured to communicate with the mobile computing device,
wherein the hearing aid device comprises:
a microphone;
a hearing aid device transceiver configured to communicate with the mobile computing device; and
a hearing aid device processor coupled to the microphone and the hearing aid device transceiver, wherein the hearing aid device processor is configured with processor-executable instructions to perform operations comprising:
receiving sound signals from the microphone;
determining whether the sound signals represent meaningful sound;
activating the hearing aid device transceiver in response to determining that the sound signals represent meaningful sound;
transmitting the sound signals to the mobile computing device via the hearing aid device transceiver;
receiving processed sound signals from the mobile computing device via the hearing aid device transceiver;
generating sound from the received processed sound signals; and
deactivating the hearing aid device transceiver when the transceiver is active in response to determining that the sound signals do not represent meaningful sound, and
wherein the mobile computing device comprises:
a memory;
a mobile computing device transceiver configured to communicate with the hearing aid device; and
a mobile computing device processor coupled to the memory and the mobile computing device transceiver, and wherein the mobile computing device processor is configured with processor-executable instructions to perform operations comprising:
receiving sound signals from the hearing aid device via the mobile computing device transceiver;
processing the sound signals; and
transmitting the processed sound signals to the hearing aid device via the mobile computing device transceiver.

24. The system of claim 23, wherein the hearing aid device processor is configured with processor-executable instructions to perform operations such that determining whether the sound signals represent meaningful sound comprises processing the sound signals using a speech detection module to detect speech.

25. The system of claim 23, wherein the hearing aid device transceiver and the mobile computing device transceiver are one of a Bluetooth® transceiver and a Bluetooth® Low Energy transceiver.

26. The system of claim 23, wherein the mobile computing device further comprises a digital signal processor and wherein the mobile computing device processor is configured with processor-executable instructions to perform operations such that processing the sound signals comprises processing the sound signals on the digital signal processor.

27. The system of claim 23, wherein:
the microphone is a unidirectional microphone configured to preferentially receive sounds directed toward a user's face;
the hearing aid device further comprises an omnidirectional microphone coupled to the processor and configured to receive sounds from multiple directions; and
the hearing aid device processor is configured with processor-executable instructions to perform operations such that receiving sound signals from the microphone comprises:
receiving sound signals from the unidirectional microphone; and
receiving sound signals from the omnidirectional microphone.

28. The system of claim 27, wherein the hearing aid device processor is configured with processor-executable instructions to perform operations such that transmitting the sound signals to the mobile computing device via the hearing aid device transceiver comprises:
subtracting the sound signals received from the omnidirectional microphone from the sound signals received from the unidirectional microphone to produce isolated sound signals; and
transmitting the isolated sound signals to the mobile computing device via the transceiver.
